(19) United States
(12) Patent Application Publication
(10) Pub. No.: US 2005/0028307 A1
(43) Pub. Date: Feb. 10, 2005

(54) Snake

(76) Inventor: Kuei-Kun Wu, Kaohsiung (TW)

Correspondence Address: VENABLE, BAETJER, HOWARD AND CIVILETTI, LLP, P.O. BOX 34385, WASHINGTON, DC, 20043-9998, US

(21) Appl. No.: 10/634,864

(22) Filed: Aug. 6, 2003

(51) Int. Cl. B08B 9/04

(52) U.S. Cl. 15/104.33; 15/104.2

(57) ABSTRACT

A snake includes a handle, a flexible cable, multiple brushes with various sizes and a crank. The handle has a proximal end, a distal end and a ring with an eye on the distal end. The flexible cable is made of glass fiber and has a rear end attached to the proximal end of the handle, a front end and a connector attached to the front end of the flexible cable. A brush shaft has a rear end attached to the connector, a front end and a head attached to the front end of the brush shaft. The brushes each have a shank that can detachably attach to the head of the brush shaft. The crank is L-shaped and has a longitudinal arm, a transverse arm with a free end to be inserted through the ring and a cap with an aperture attached to the transverse arm of the crank.

### BACKGROUND OF THE INVENTION

1. Field of the Invention

The present invention relates to a snake, and more particularly to a tool that can be used to remove obstructions from pipes or to guide lines or wires through pipes or conduits.

2. Description of Related Art

Conventional tools for removing obstructions from pipes have a fixed brush at the front end. For pipes with different diameters, tools with brushes corresponding to the respective pipes must be used. Furthermore, another tool for guiding lines such as electrical wires through pipes or conduits does not have any other function except guiding the lines.

Therefore, the invention provides a snake to mitigate or obviate the aforementioned problems.

### SUMMARY OF THE INVENTION

The main objective of the invention is to provide a snake that has changeable brushes corresponding to various pipes and can be used to guide lines through pipes or conduits.

Other objectives, advantages and novel features of the invention will become more apparent from the following detailed description when taken in conjunction with the accompanying drawings.

### BRIEF DESCRIPTION OF THE DRAWINGS

FIG. 1 is an exploded perspective view of a snake in accordance with the present invention;

FIG. 2 is an operational side plan view of the snake with a large brush to unblock a flexible duct;

FIG. 3 is an operational side plan view of the snake with a small brush to unblock a drainpipe; and

FIG. 4 is an operational side plan view of the snake used to guide a line through a conduit.

### DETAILED DESCRIPTION OF THE PREFERRED EMBODIMENT

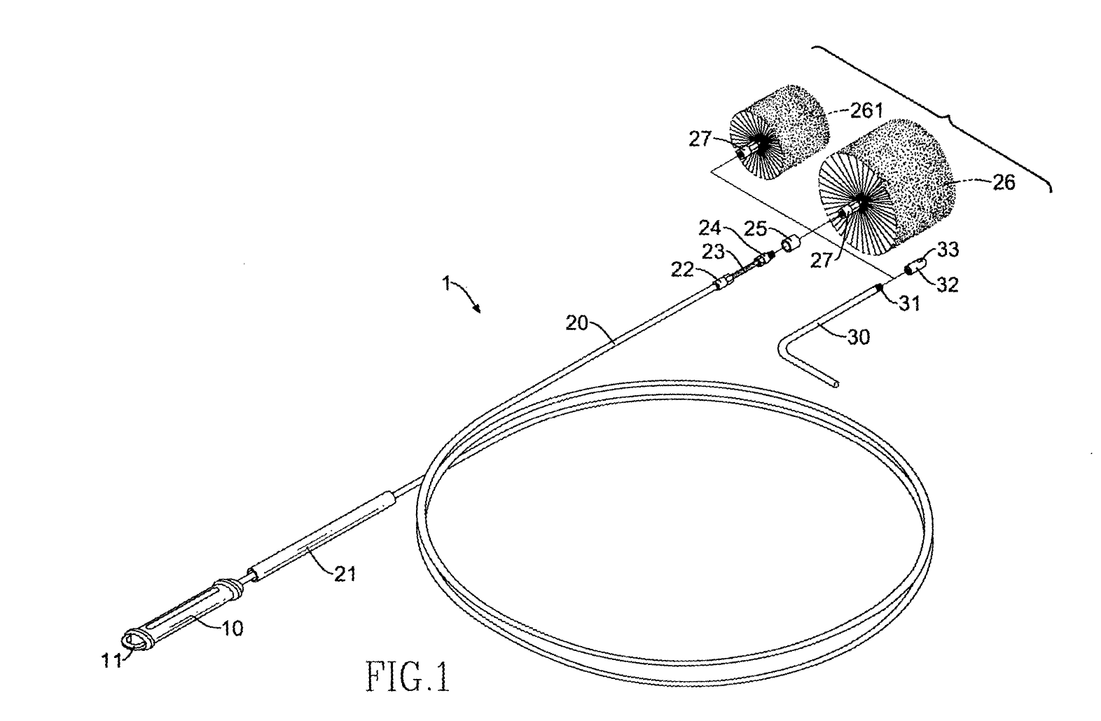

With reference to FIG. 1, a snake (1) in accordance with the present invention is composed of a handle (10), a flexible cable (20), multiple brushes (26, 261) and a crank (30).

The handle (10) has a proximal end (not numbered), a distal end (not numbered) and a ring (11). The ring (11) has an eye (not numbered) and is formed on the distal end of the handle (10).

The flexible cable (20) is made of glass fiber and has a rear end (not numbered), a front end (not numbered), a connector (22) and a brush shaft (23) and optionally a sleeve (21). The rear end of the flexible cable (20) is securely attached to the proximal end of the handle (10). The glass fiber has good elasticity, so that the flexible cable (20) will easily bend in and extend through pipes or conduits. The sleeve (21) is mounted loosely around the flexible cable (20) so the flexible cable (20) will rotate inside the sleeve (21). The connector (22) is attached to the front end of the flexible cable (20). The brush shaft (23) is a steel cable and has a rear end (not numbered), a front end (not numbered), a head (24) and a bushing (25). The rear end of the brush shaft (23) is attached to the connector (22). The head (24) has an external thread (not numbered) and is connected to the front end of the brush shaft (23).

The brushes (26, 261) are various sizes and are attached to the threaded head (24) on the brush shaft (23). Each of the brushes (26, 261) has a shank (27). The shank (27) is hollow and has an internal thread (not numbered). The internal thread screws onto the external thread on the head (24). The bushing (25) is mounted around the shank (27) outside the head (24) to prevent the brush (26, 261 from loosening inappropriately in operation.

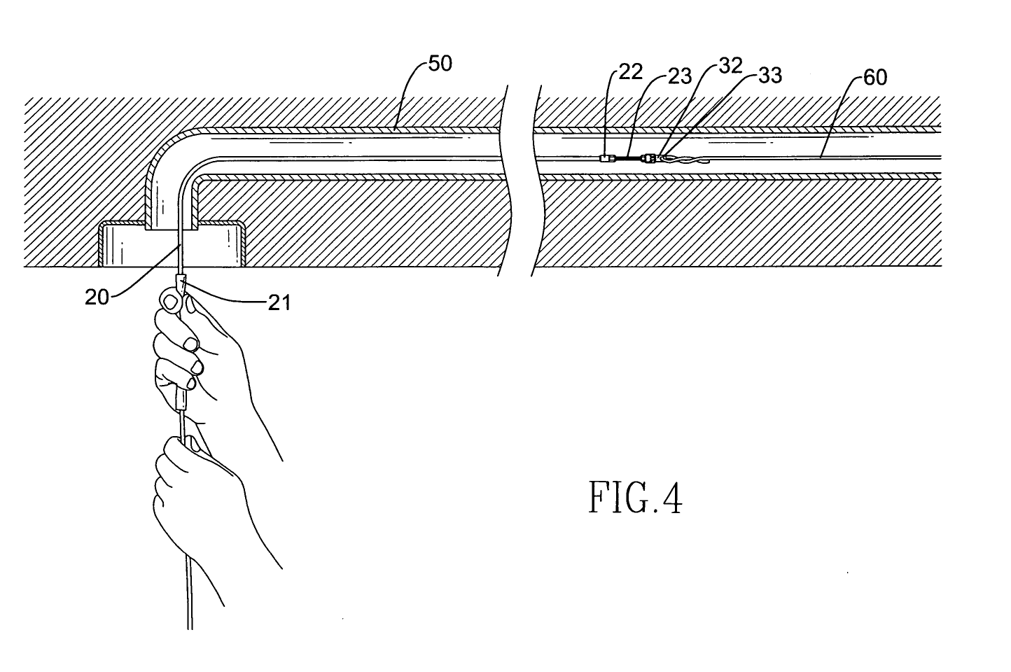

The crank (30) is L-shaped and has a longitudinal arm (not numbered), a transverse arm (not numbered) and a cap (32). The transverse arm has a diameter and a threaded free end (31) and can extend through the ring (11). The cap (32) has a transverse aperture (33) and an outside diameter larger than the diameter of the transverse arm of the crank (30) and the eye of the ring (11) and attaches to the threaded free end (31) of the crank (30). With the cap (32), the crank (30) can not be freely removed from the ring (11) in operation. The cap (32) also can be attached to the head (24) to replace the brushes (26, 261). With reference to FIG. 4, a line (60) can be attached to the aperture (33) when the cap (32) attached to the head (24).

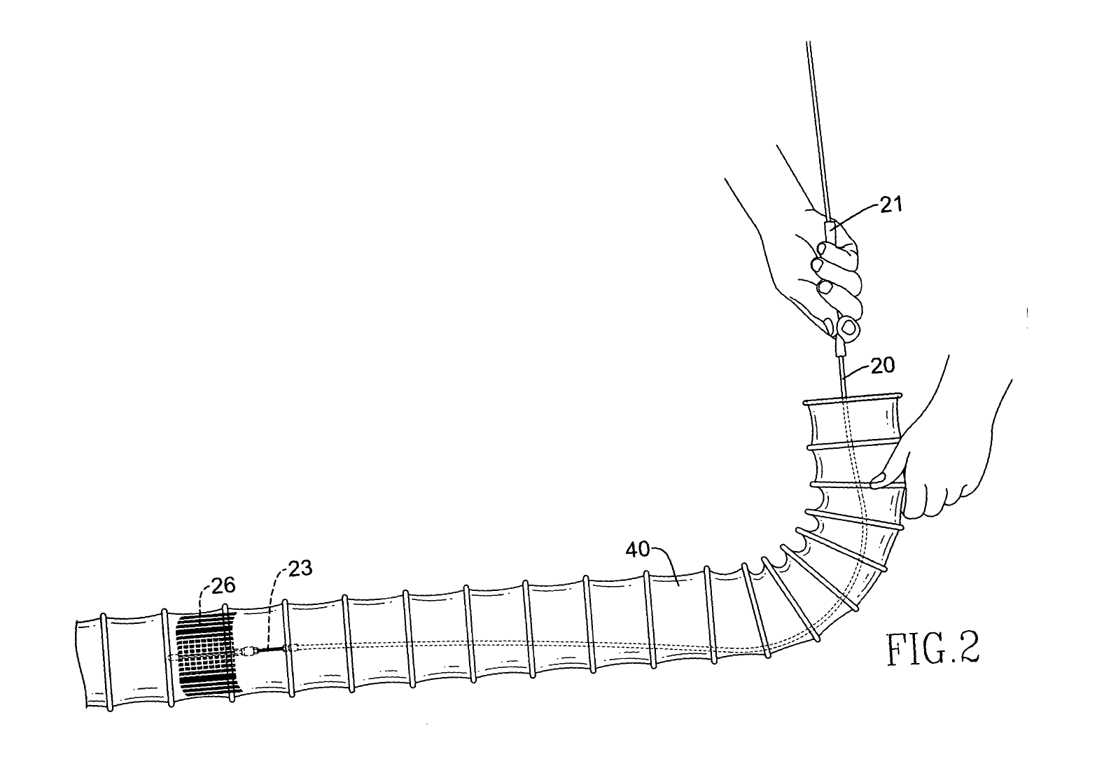

With reference to FIG. 2, for unblocking some tubes with large sizes, such as a flexible duct (40) attached to a clothes dryer (not shown), the large brush (26) with a large diameter is attached the brush shaft (23). A person holds the sleeve (21) and pushes the flexible cable (20) and the brush (26) into the flexible duct (40) to unblock or clean the flexible duct (40).

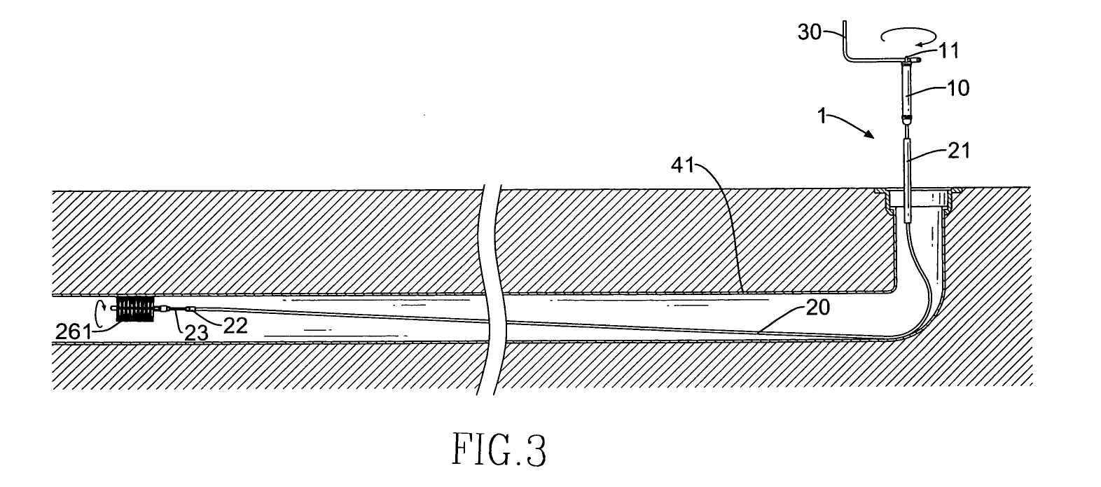

With reference to FIG. 3, the snake (1) also can be used to remove obstructions from small pipes, such as a drainpipe (41). The small brush (261) with a small diameter is attached to the brush shaft (23). The flexible cable (20) and the small brush (261) are pushed into the drainpipe (41), and the crank (30) is inserted through the ring (11) and turned to rotate the flexible cable (20) and the small brush (261), so that the drainpipe (41) is unblocked and its inner wall is cleaned.

With reference to FIG. 4, the snake (1) can also be used to guide a line (60) such as an electrical wire or a signal cable through a pipe or conduit. The cap (32) is attached to the brush shaft (23). The user holds the sleeve (20) and pushes the flexible cable (20) through a pipe or conduit (50) and attaches the line (60) to the cap (32) through the aperture (33). The flexible cable (20) is then pulled back by the user to draw the line (60) through the conduit (50).

The invention has the following advantages.

1. Various brushes can be attached to the snake to unblock pipes with different sizes, or a cap can be attached to the snake to pull lines through a conduit.

2. The flexible cable is made of glass fiber with high elasticity, so the flexible cable will not rust, and the user can easily extend the flexible cable through pipes or conduits and safely pull wires.

3. The brush shaft attached to the front end of the flexible cable provides a reinforced strength for the flexible cable to remove clogs in pipes.

4. By holding the sleeve, the user can push the flexible cable into pipes more easily.

5. The inner walls of pipes are conveniently cleaned by turning the crank mounted on the handle.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A snake comprising:
a handle having a proximal end, a distal end and a ring having an eye formed at the distal end;
a flexible cable made of glass fiber, having a rear end attached to the proximal end of the handle, a front end, a connector attached to the front end of the flexible cable and a brush shaft having a rear end attached to the connector, a front end and a head attached to the front end of the brush shaft;
multiple brushes with various sizes, each brush having a shank detachably connected to the head of the brush shaft; and
an L-shaped crank having a longitudinal arm, a transverse arm having a free end inserted through the ring; and
a cap mounted on the transverse arm and having a transverse aperture.

2. The snake as claimed in claim 1 further comprising a sleeve -movably around the flexible cable.

3. The snake as claimed in claim 1, wherein the head has an external thread, and the shank is hollow and has an internal thread screwed onto the external thread to attach the brush to the head.

4. The snake as claimed in claim 3, wherein the free end of the transverse arm of the crank has an external thread, and the cap has an internal thread screwed onto the external thread of the transverse arm.

5. The snake as claimed in claim 4, wherein the internal thread in the cap can be screwed onto the external thread on the head to attach the cap to the head.

6. The snake as claimed in claim 1 further comprising a bushing mounted around the shank outside the head.
